(19) United States
(12) Patent Application Publication
(10) Pub. No.: US 2013/0007363 A1
(43) Pub. Date: Jan. 3, 2013

(54) CONTROL DEVICE AND CONTROL METHOD

(75) Inventor: Kunihiko KASSAI, Tsuzuki (JP)

(73) Assignee: FUJITSU LIMITED, Kawasaki-shi (JP)

(21) Appl. No.: 13/447,476

(22) Filed: Apr. 16, 2012

(30) Foreign Application Priority Data
Jun. 30, 2011 (JP) 2011-145829

(51) Int. Cl. G06F 12/00

(52) U.S. Cl. 711/114; 711/E12.001

(57) ABSTRACT

A control device includes a counter configured to count the number of files stored in a first volume having a data storage area to which an upper limit of the number of files which being stored in the data storage area is set; an interpreting unit configured to interpret an inclination to increase in a capacity of the files stored in the first volume upon the number of the files counted by the counter being greater than a particular number; and a volume controller configured to generate a second volume upon the interpreting unit interpreting the inclination as such that the capacity of the files increases by an amount greater than a particular amount within a certain time length.

### CROSS-REFERENCE TO RELATED APPLICATION

This application is based upon and claims the benefit of priority of the prior Japanese Patent Application No. 2011-145829, filed on Jun. 30, 2011, the entire contents of which are incorporated herein by reference.

### FIELD

The embodiments discussed herein are related to a control device and a control method.

### BACKGROUND

A technology for integrating a plurality of RAID (Redundant Arrays of Inexpensive/Independent Disks) groups so as to generate one storage pool and to generate one or a plurality of logical volumes (flexible volumes) as desired is known (ETRNUS NR1000F Series [online] FUJITSU Corporation).

It is enabled to generate a 64-bit flexible volume which uses a 64-bit basis on which an address of data to be stored is managed in a storage pool in recent years. The 64-bit flexible volume may have a larger storage capacity than that of, e.g., a 32-bit flexible volume which uses a 32-bit basis on which an address of data to be stored is managed. Further, upon securing a storage capacity as large as that of the 32-bit flexible volume, the 64-bit flexible volume may be content with a smaller parity disk percentage of the flexible volume than a parity disk percentage of the 32-bit flexible volume, and thus may effectively make use of resources in the storage pool.

### SUMMARY

According to an aspect of the invention, a control device includes a counter configured to count the number of files stored in a first volume having a data storage area to which an upper limit of the number of files which being stored in the data storage area is set; an interpreting unit configured to interpret an inclination to increase in a capacity of the files stored in the first volume upon the number of the files counted by the counter being greater than a particular number; and a volume controller configured to generate a second volume upon the interpreting unit interpreting the inclination as such that the capacity of the files increases by an amount greater than a particular amount within a certain time length.

The object and advantages of the invention will be realized and attained by unit of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

These and/or other aspects and advantages will become apparent and more readily appreciated from the following description of the embodiments, taken in conjunction with the accompanying drawing of which:

FIG. 1 illustrates a storage apparatus of a first embodiment;

FIG. 2 is a block diagram which depicts a storage system of a second embodiment;

FIG. 3 is a block diagram which illustrates a function of a controller of the second embodiment;

FIG. 4 illustrates a volume information management table;

FIG. 5 illustrates a file information management table;

FIG. 6 is a flowchart which depicts a process run by an aggregate controller;

FIG. 7 illustrates a process for shifting to a 64-bit aggregate volume; and

FIG. 8 illustrates a process for shifting to a 64-bit aggregate volume.

### DESCRIPTION OF EMBODIMENTS

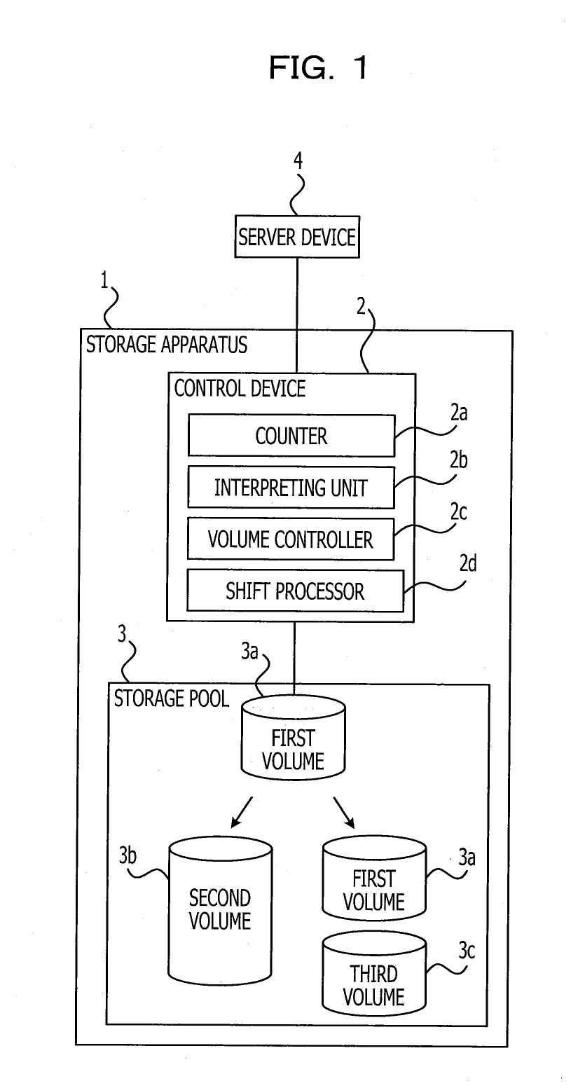

FIG. 1 illustrates a storage apparatus of a first embodiment.

The storage apparatus 1 of the first embodiment has a control device 2 and a storage pool 3. The storage pool 3 is a virtual storage area formed by one or a plurality of drive devices (an HDD (Hard Disk Drive), an SSD (Solid State Drive), etc.). In the storage pool 3, a logical first volume 3a formed by part of data storage area in the drive devices is generated by the control device 2. The first volume 3a has a storage area (e.g., of 16 TB (Terabytes)) for which an upper limit is set to the number of files that the controller 2 may write into the storage area. The storage pool 3 includes a data storage area in which a plurality of logical volumes may be made except for the first volume 3a.

The control device 2 is connected to the first volume 3a via a communication line. The control device 2 controls file access from a server device 4 to be used for business, etc., to the first volume 3a. That is, the control device 2 controls an operation for writing data accepted from the server device 4 into the first volume 3a and an operation accepted from the server device 4 for reading data stored in the first volume 3a. The control device 2 has a counter 2a, an interpreting unit 2b, a volume controller 2c and a shift processor 2d. Incidentally, the counter 2a may be implemented by unit of a function that a CPU (Central Processing Unit) included in the control device 2 has, and so may the interpreting unit 2b, the volume controller 2c and the shift processor 2d.

The counter 2a counts the number of files stored in the first volume 3a.

If the number of files counted by the counter 2a is greater than a particular number (e.g., 90% of the upper limit), the interpreting unit 2b interprets an inclination to increase in a capacity of the files stored in the first volume 3a (capacity being used for data storage). In order to interpret the inclination to increase in the capacity being used by the files, e.g., the interpreting unit 2b decides whether the capacity being used by the files increases at a rate greater than a particular value within a certain time length.

Even if the number of the files counted by the counter 2a is greater than the particular number, the volume controller 2c expands a data storage area in the first volume 3a so as to generate a second volume 3b (e.g., of 100 TB) if the capacity of the files increases at a rate greater than the particular value within the certain time length. The volume controller 2c runs the above process on the basis that the interpretation made by the interpreting unit 2b leads to a prediction of a relatively high probability of an increase in the file size. Incidentally, the first volume 3a may be expanded so that the second volume 3b is generated, or a new volume may be generated as the second volume 3b separately from the first volume 3a. As the volume controller 2c generates the second volume 3b, the controller 2 may avoid generating a new volume and reduce a processing load of the process for shifting a volume even if the capacity of the files increases.

The shift processor 2d runs a process for enabling the server device 4 to access files in the second volume 3b having been generated such as to copy a file stored in the first volume 3a into the second volume 3b generated by the volume controller 2c.

Meanwhile, if the interpretation made by the interpreting unit 2b leads to a conclusion that the capacity of the files does not increase by an amount greater than a particular amount within a certain time length, the volume controller 2c avoids generating the second volume 3b. The volume controller 2c runs the above process on the basis that the interpretation made by the interpreting unit 2b leads to a prediction of a relatively low probability of an increase in the file size. The control device 2 may avoid generating a second volume 3b including a data storage area expecting an insignificant increase in the usage rate, so as to control production of a volume having an excessively large data storage area.

Incidentally, the volume controller 2c may generate a new third volume 3c if the number of files stored in the first volume 3a reaches the upper limit. Incidentally, the third volume 3c does not limit its capacity in particular.

If the volume controller 2c of the storage apparatus 1 decides that a capacity of files stored in the first volume 3a does not increase by an amount greater than a particular amount within a certain time length, the storage apparatus 1 avoids generating the second volume 3b expanded from the data storage area in the first volume 3a. Thus, the storage apparatus 1 may control production of a volume having an excessively large data storage area more effectively than in a case where a second volume 3b is typically generated if the number of files counted by the counter 2a is greater than a particular number. The storage apparatus 1 may thereby save the storage area in the storage pool 3.

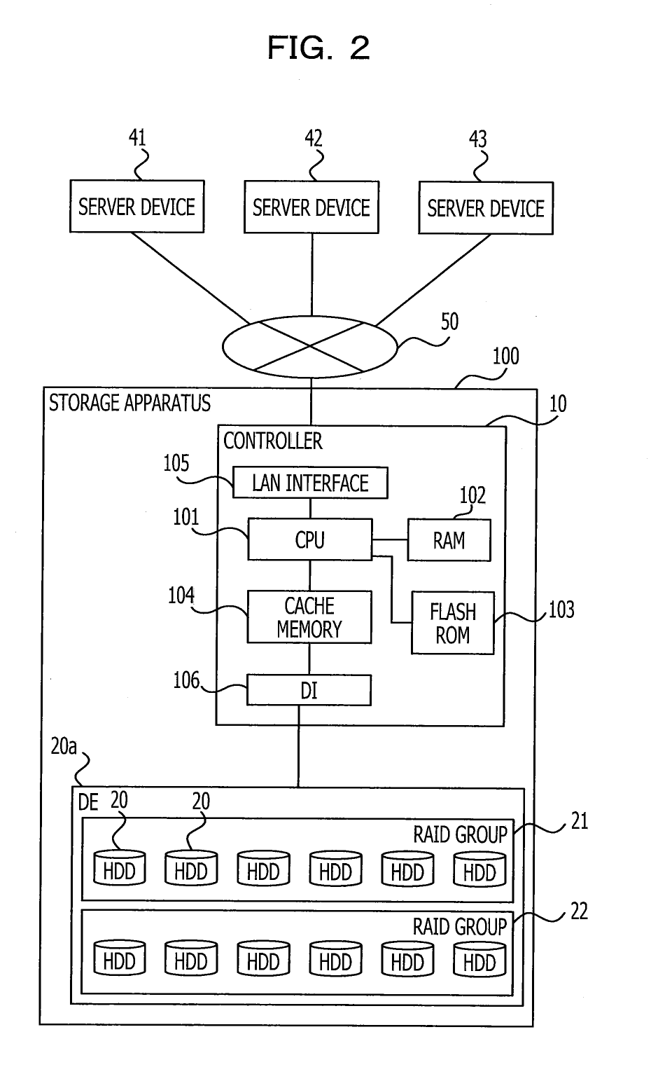

FIG. 2 is a block diagram which depicts a storage system of a second embodiment.

The storage system depicted in FIG. 2 has server devices 41, 42 and 43, and a storage apparatus 100 connected to the server devices 41, 42 and 43 via a LAN (Local Area Network).

The storage apparatus 100 is a NAS (Network Attached Storage) and has a drive enclosure (DE) 20a including a plurality of HDDs 20, and a controller 10 which manages a physical storage area in the drive enclosure 20a according to the RAID technology. The controller 10 is an exemplary control device. Incidentally, the drive enclosure 20a has, although not limited to, the HDD 20 as an exemplary recording medium, and may use another recording medium such as an SSD. Unless being distinguished from one another, the plural HDDs 20 that the drive enclosure 20a has is called an “HDD 20 group”, hereafter.

Incidentally, the number of controllers that the storage apparatus 100 has is not limited to one, and control redundancy of the HDD 20 group may be secured by two or more controllers. Further, although the storage apparatus 100 being a NAS will be explained according to the embodiment, functions that the controller 10 has may be applied to another kind of storage apparatus, e.g., SAN (Storage Area Network).

The server device 41 accesses and exchanges data with the storage apparatus 100 on a file basis, and so do the server devices 42 and 43. The server device 41 accesses and exchanges data with the storage apparatus 100 by calling a name which identifies a file, e.g., a file name or a shared name, and so do the server devices 42 and 43. The controller 10 controls file access to a physical storage area in the HDDs 20 that the drive enclosure 20a has in response to a request for file access coming from each of the server devices 41, 42 and 43 according to the RAID technology.

The controller 10 has a CPU 101, a RAM (Random Access Memory) 102, a flash ROM 103, a cache memory 104, a LAN interface 105 and a device interface (DI) 106.

The CPU 101 runs a program stored in the flash ROM 103, etc., so as to supervise and entirely control the controller 10. The RAM 102 temporarily stores therein at least part of an OS (Operating System) and application programs to be run by the CPU 101, and various kinds of data desirable for a programmed process. The flash ROM 103 is a non-volatile memory and stores therein the OS and application programs to be run by the CPU 101, and various kinds of data desirable for running of the programs.

Further, the flash ROM 103 works as a shelter for data stored in the cache memory 104 in a case where, e.g., the storage apparatus 100 fails to be supplied with power.

The cache memory 104 temporarily stores therein a file written in the HDD 20 group and a file read from the HDD 20 group.

Then, upon being instructed to read a file by the server device 41, 42 or 43, e.g., the controller 10 decides whether the file to be read is stored in the cache memory 104. If the file to be read is stored in the cache memory 104, the controller 10 sends the file to be read stored in the cache memory 104 to the server device 41, 42 or 43. The controller 10 may send the file to the server device 41, 42 or 43 more quickly than in a case where a file to be read is read from the HDD 20 group.

Further, the cache memory 104 may temporarily store therein a file desirable for a process to be run by the CPU 101. The cache memory 104 is, e.g., a semiconductor memory such as an SRAM, a DRAM, etc. Further, the cache memory 104 has, e.g., a storage capacity of, although not limited to, 2-64 GB.

The LAN interface 105 is connected to a LAN 50 and to the server devices 41, 42 and 43 via the LAN 50. The LAN interface 105 sends and receives a file from the server devices 41, 42 and 43 to the controller 10 and vice versa by using protocols such as NFS (Network File System), CIFS (Common Internet File System) or HTTP (HyperText Transfer Protocol).

The device interface 106 is connected to the drive enclosure 20a. The device interface 106 provides an interface function to send and receive a file, from the HDD 20 group that the drive enclosure 20a has to the cache memory 104 and vice versa. The controller 10 sends and receives a file to and from the HDD 20 group that the drive enclosure 20a has via the device interface 106.

A RAID group is formed in the drive enclosure 20a by one or a plurality of the HDDs 20 that the drive enclosure 20a has.

FIG. 2 illustrates RAID groups 21 and 22 each forming a RAID-DP (Double Parity) (registered trademark) structure in which two parity disks are installed in a RAID group in a way of RAID 6 implementation. Incidentally, the RAID structures of the RAID groups 21 and 22 are exemplary only, and not limited to the illustrated RAID structures. The RAID group 21 may have any number of HDDs 20, e.g., and so may the RAID group 22. Further, the RAID group 21 may be formed according to any RAID system such as RAID 5, etc., and so may the RAID group 22. Then, a function that the controller 10 has will be explained.

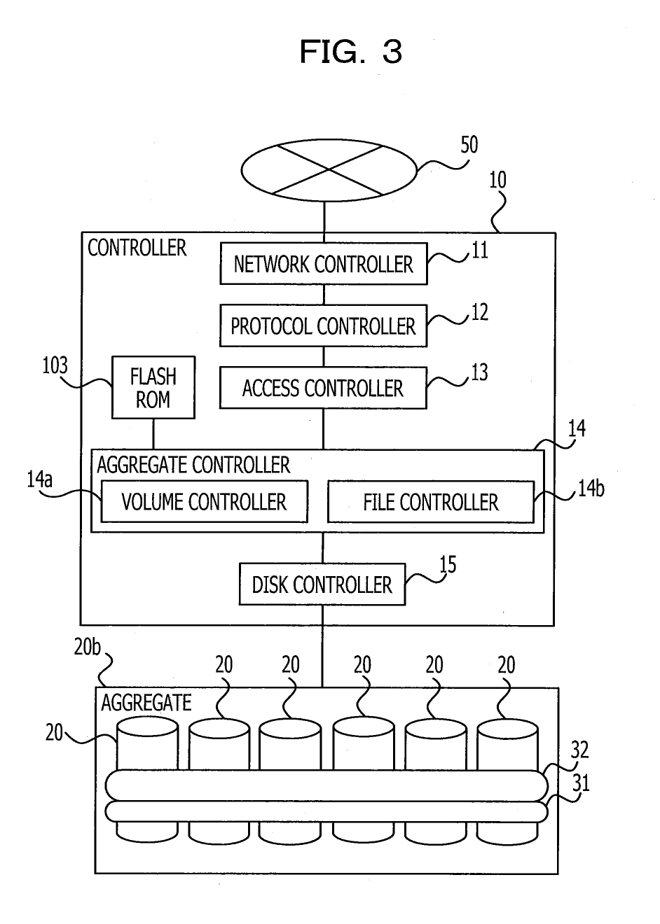

FIG. 3 is a block diagram which illustrates the function of the controller of the second embodiment.

The controller 10 has an aggregate 20b formed by the RAID groups 21 and 22 treated together as one virtual storage area. One or a plurality of logical volumes may be generated in the aggregate 20b. A volume generated in the aggregate 20b is called an “aggregate volume” hereafter. FIG. 3 depicts two aggregate volumes 31 and 32.

The controller 10 has a network controller 11, a protocol controller 12, an access controller 13, an aggregate controller 14 and a disk controller 15.

The network controller 11 builds a network with each of the servers 41, 42 and 43 via the LAN 50.

The protocol controller 12 performs communication with the servers 41-43 by using the protocols described above such as NFS, CIFS, etc.

The access controller 13 confirms and certifies power to access from the server 41, 42 or 43 to the aggregate volume 31 or 32.

The aggregate controller 14 is an example of the counter, the decision unit and the volume controller. The aggregate controller 14 controls access from the server 41, 42 or 43 to the aggregate volume 31 or 32. Further, the aggregate controller 14 has a function to generate an aggregate volume. The aggregate controller 14 may generate an aggregate volume having a storage capacity of, e.g., 20 MB and over on a 4 KB basis. The aggregate controller 14 may change the storage capacity of the aggregate volume 31 or 32 having been generated. Further, the aggregate controller 14 watches and manages a volume information management table generated in the aggregate 20b for managing the aggregate volume. The aggregate controller 14 controls processes, e.g., for generating, deleting or shifting an aggregate volume by using the volume information management table. The process for shifting an aggregate volume includes processes for generating a new aggregate volume, copying a file stored in an existing aggregate volume into the aggregate volume having been generated, and changing an access path connection of the server device 41, 42 or 43 with the existing aggregate volume to a connection with the new aggregate volume having been generated.

Incidentally, the flash ROM 103 stores therein an OS of a first version supporting the aggregate volumes 31 and 32 in which 32-bit addresses for managing the data storage areas in the HDDs 20 are used. The aggregate controller 14 runs the OS of the first version stored in the flash ROM 103, so as to generate the aggregate volumes 31 and 32 each having a maximum storage capacity of 16 TB.

If an administrator of the storage apparatus 100 (merely called “administrator” hereafter) runs an updating process, the OS of the first version stored in the flash ROM 103 may be updated to an OS of a second version. The OS of the second version supports an aggregate volume in which 64-bit addresses are used in order that the data storage areas in the HDDs 20 are managed. The CPU 101 runs the OS of the second version stored in the flash ROM 103 so that the aggregate controller 14 may generate an aggregate volume having a maximum storage capacity of 100 TB. The maximum numbers of files that may be filed in the 32-bit aggregate volume and in the 64-bit aggregate volume are equally set, though. The administrator may set the maximum numbers of files.

The aggregate controller 14 has a volume manager 14a and a file manager 14b.

The volume manager 14a manages a volume information management table generated on an aggregate volume basis in which data related to the aggregate 20b is stored.

The file manager 14b manages a file information management table set on a file basis in which data related to files is stored. Incidentally, the volume information management table and the file information management table are stored in the RAM 102.

The disk controller 15 accesses the HDD 20 group which builds the aggregate volumes 31 and 32 and the 64-bit aggregate volume having been generated as requested by the aggregate controller 14.

Then, what is in the volume information management table will be explained.

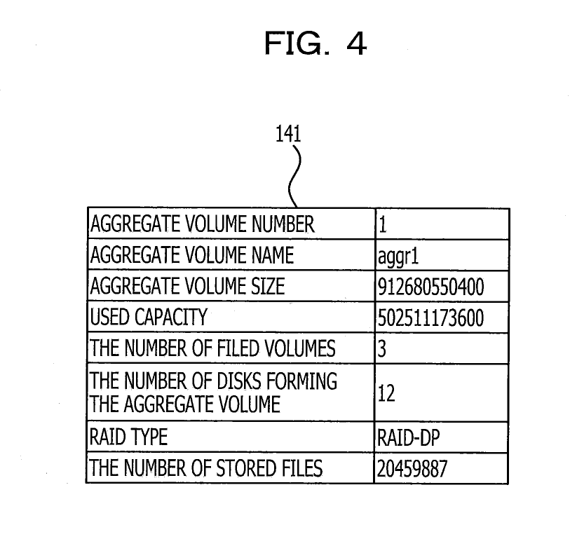

FIG. 4 illustrates the volume information management table.

The volume information management table 141 is provided with fields for an aggregate volume number, an aggregate volume name, an aggregate volume size, a used capacity, the number of filed volumes, the number of disks forming the aggregate volume, a RAID type and the number of stored files. Pieces of information arranged in a horizontal direction are related to each other.

A number used for management of the volume information management table 141 is set in the field of the aggregate volume number.

A name used for identification of the aggregate volume is set in the field of the aggregate volume name.

A storage capacity (in bytes) that the relevant aggregate volume is provided with is set in the field of the aggregate volume size.

A storage capacity (in bytes) being used for data storage in the relevant aggregate volume is set in the field of the used capacity.

The number of logical volumes to be generated in the relevant aggregate volume (called “sub-volume(s)” hereafter) is set in the field of the number of filed volumes. A logical sub-volume may further be generated in the aggregate volume in this way.

The number of HDDs 20 which build the relevant aggregate volume is set in the field of the number of disks forming the aggregate volume.

A RAID type of the relevant aggregate volume is set in the field of the RAID type.

The number of files stored in the relevant aggregate volume is set in the field of the number of stored files.

Then, what is in the file information management table will be explained.

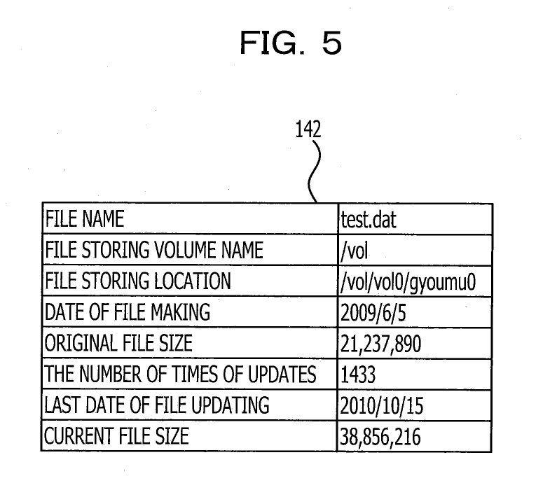

FIG. 5 illustrates the file information management table.

The file information management table 142 is provided with fields for a file name, a file storing volume name, a file storing location, a date of file generation, an original file size, the number of times of updates, a last date of file updating and a current file size. Pieces of information arranged in a horizontal direction are related to each other.

A name used for identification of a file is set in the field of the file name.

A name used for identifying a name of a volume in the aggregate 20b in which the relevant file is stored is set in the field of the file storing volume name.

A piece of information for identifying where the relevant file is stored in the aggregate 20b is set in the field of the file storing location.

The date on which the relevant file was generated for the first time is set in the field of the date of file generation. The date does not change even if the relevant file is overwritten.

A file size at the time when the relevant file was generated for the first time is set in the field of the original file size.

How many times the relevant file was updated is set in the field of the number of times of updates.

The date on which the relevant file was updated last is set in the field of the last date of file updating.

A current size of the relevant file (file size at the time when the relevant file was updated last) is set in the field of the current file size.

Then, a process to be run by the aggregate controller 14 when the controller 10 starts to work for the first time after the OS stored in the flash ROM 103 is updated from the OS of the first version to the OS of the second version will be explained.

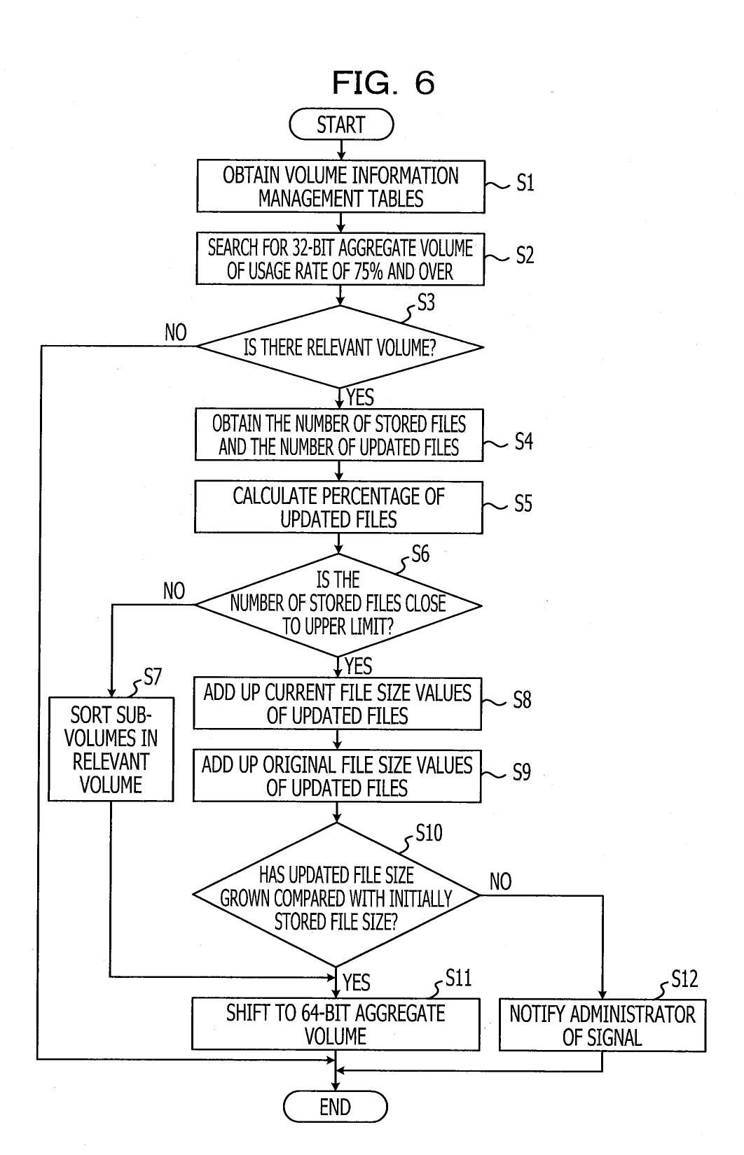

FIG. 6 is a flowchart which depicts the process run by the aggregate controller 14.

(Operation S1) The aggregate controller 14 obtains all the volume information management tables 141 managed by the volume manager 14a. Then, shift to an operation S2.

(Operation S2) The aggregate controller 14 refers to the fields of the aggregate volume size and the used capacity in each of the volume information management tables 141 obtained in the operation S1, and calculates in each of the volume information management tables 141a percentage of the used capacity in the aggregate volume size. Then, the aggregate controller 14 searches for a 32-bit aggregate volume of a usage rate of 75% and over. Incidentally, the usage rate of 75% is exemplary only as preset by the administrator, and may be changed to any percentage value. After the above search, shift to an operation S3.

(Operation S3) The aggregate controller 14 decides whether there is a 32-bit aggregate volume of a usage rate of 75% and over as a result of the search in the operation S2. If there is a volume of a usage rate of 75% and over (Yes of operation 3), shift to an operation S4. If there is no volume of a usage rate of 75% and over (No of operation 3), end the process depicted in FIG. 6. That is, if there is no volume of a usage rate of 75% and over, no 32-bit aggregate volume is processed to be shifted to a 64-bit aggregate volume as described later.

(Operation S4) The aggregate controller 14 obtains the number of stored files in the volume information management table 141 of a 32-bit aggregate volume of a usage rate of 75% and over (called “relevant volume” hereafter). Further, the aggregate controller 14 refers to the date of file generation and the last date of file updating in the file information management table 142 of each of relevant volumes. The aggregate controller 14 counts the number of files each having a last date of file updating within six months after the date of file generation, i.e., the number of files updated less than six months ago (called the number of updated files hereafter). Incidentally, the interval less than six months is exemplary only as preset by the administrator, and may be changed to any interval length. After the aggregate controller 14 finishes obtaining the number of stored files and the number of updated files, shift to an operation S5.

(Operation S5) The aggregate controller 14 divides the number of updated files obtained in the operation S4 by the number of stored files so as to calculate a percentage of the number of updated files in the number of stored files. Then, shift to an operation S6.

(Operation S6) The aggregate controller 14 decides whether the number of stored files obtained in the operation S4 is close to the upper limit. The aggregate controller 14 may decide that the number of stored files is close to the upper limit if, e.g., the percentage calculated in the operation S5 is not smaller than a percentage preset as an upper limit, or if the number of stored files is not smaller than a value preset as an upper limit. The administrator may select the percentage or the number of files to be preset as the upper limit. If the aggregate controller 14 decides that the number of stored files obtained in the operation S4 is close to the upper limit (Yes of the operation S6), shift to an operation S8. Unless the aggregate controller 14 decides that the number of stored files obtained in the operation S4 is close to the upper limit (No of the operation S6), shift to an operation S7.

(Operation S7) The aggregate controller 14 sorts sub-volumes in the relevant volume into descending order of an update frequency and of the usage rate calculated in the operation S2. The sorting process may make access to a file stored in a 64-bit aggregate volume on which a shifting process described later is carried out more efficient. Then, shift to an operation S11.

(Operation S8) The aggregate controller 14 adds up the current file size values of the updated files. Specifically, the aggregate controller 14 refers to all the file information management tables 142. Then, the aggregate controller 14 adds up the current file size values in the file information management tables 142 each having a volume name in the field of the file storing volume name which agrees with the relevant volume name. Then, shift to an operation S9.

(Operation S9) The aggregate controller 14 adds up the original file size values of the updated files. Specifically, the aggregate controller 14 refers to all the file information management tables 142. Then, the aggregate controller 14 adds up the original file size values in the file information management tables 142 each being provided with the relevant volume name set into the field of the file storing volume name. Then, shift to an operation S10. Incidentally, the operations S8 and S9 may be processed in parallel.

(Operation S10) The aggregate controller 14 decides whether the sum of the current file size values of the updated files calculated in the operation S8 is not smaller than the sum of the original file size values of the updated files calculated in the operation S9 multiplied by 1.3. The coefficient 1.3 is exemplary only as preset by the administrator, and may be changed to any coefficient value larger than 1. If the sum of the current file size values of the updated files calculated in the operation S8 is not smaller than the sum of the original file size values of the updated files calculated in the operation S9 multiplied by 1.3 (Yes of operation S10), shift to an operation S11. Incidentally, other conditions for shifting to the operation 511 except for the condition in the operation S10 are that the usage rate of the relevant volume is not smaller than 75% (see the operation S3), and that the total number of the files is close to the upper limit (see the operation S6). Thus, it may be concluded that a percentage of files updated less than six months ago in an increase of the file size in the relevant volume is relatively high.

If the sum of the current file size values of the updated files calculated in the operation S8 is smaller than the sum of the original file size values of the updated files calculated in the operation S9 multiplied by 1.3 (No of operation S10), shift to an operation S12. Incidentally, other conditions for shifting to the operation S12 except for the condition in the operation S10 are that the usage rate of the relevant volume is not smaller than 75% (see the operation S3), and that the total number of the files is close to the upper limit (see the operation S6). Thus, it may be concluded that a percentage of files updated less than six months ago in an increase of the file size in the relevant volume is relatively low.

(Operation S11) The aggregate controller 14 generates a 64-bit aggregate volume and copies a file stored in the relevant volume into the 64-bit aggregate volume having been generated. Then, the aggregate controller 14 changes an access path connection of the server device 41, 42 or 43 with the relevant volume to a connection with the 64-bit aggregate volume having been generated. Then, end the process depicted in FIG. 6. What is intended in running the process in the operation S11 is to expect that the file size grows after the total number of the files stored in the 32-bit aggregate volume being a source of the shift reaches the upper limit, and to shift to the 64-bit aggregate volume. Run the process in the operation S11, so that the 32-bit aggregate volume in which files relatively frequently updated less than six months ago are stored, while the upper limit of the total number of files is close, may be shifted to the 64-bit aggregate volume. Thus, the storage apparatus 100 may deal with, e.g., an increase in the file size.

(Operation S12) The aggregate controller 14 notifies the administrator of a signal to prompt him or her to generate a new aggregate volume. How to notify the administrator is, e.g., to make an LED which is not depicted blink or to produce a noticeable sound, etc. The administrator may be notified by the signal that the total number of the files is close to the upper limit (see the operation S6). Then, end the process depicted in FIG. 6. The explanation of FIG. 6 finishes here. Incidentally, the order of the operations (e.g., S8 and S9) in the flowchart depicted in FIG. 6 may be partially changed. Further, although the process run by the aggregate controller 14 after the controller 10 starts working in the first place is explained with reference to FIG. 6, the aggregate controller 14 may check condition of the 32-bit aggregate volume in the aggregate 20b at regular intervals after running the process depicted in FIG. 6 and run the process depicted in FIG. 6 at any time.

Then, the process in the operation S11 for shifting from the 32-bit aggregate volume to the 64-bit aggregate volume will be explained in more detail.

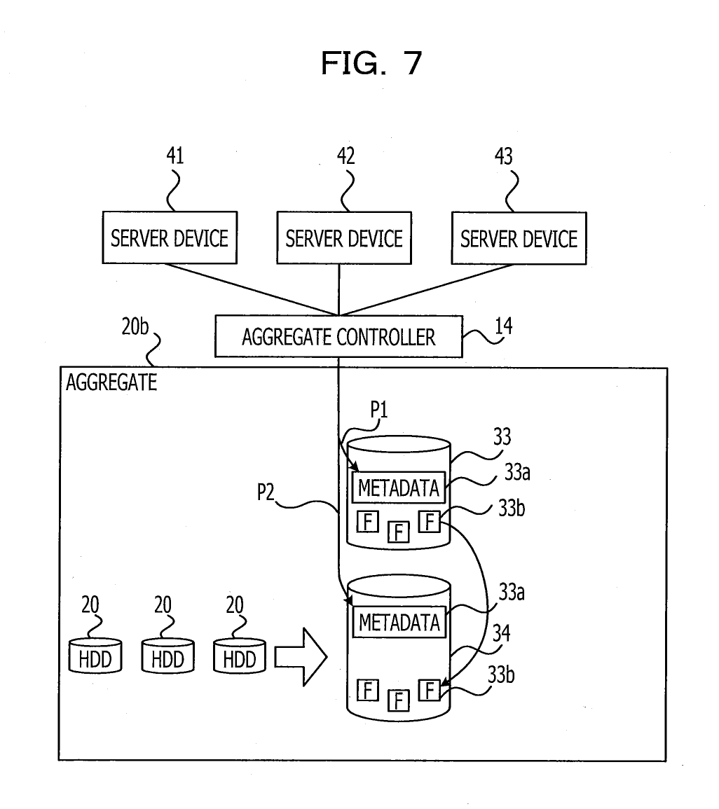

FIG. 7 illustrates the process for shifting to the 64-bit aggregate volume.

The aggregate controller 14 generates a new 64-bit aggregate volume 34 by using an HDD 20 having been unused in the aggregate 20b. Incidentally, a sub-volume having a larger storage capacity than that of a 32-bit aggregate volume 33 being a source of the shift may be generated in an existing 64-bit aggregate volume, although not depicted in FIG. 7. Then, the aggregate controller 14 copies metadata 33a and all files 33b in the 32-bit aggregate volume 33 into the 64-bit aggregate volume 34. Incidentally, the metadata 33a includes by whom and when the file 33b stored in the 32-bit aggregate volume 33 being the source of the shift is generated, a file format, a title, a comment of the file 33b, etc. After the files are copied, the aggregate controller 14 changes an access path P1 between the server devices 41, 42 and 43 and the 32-bit aggregate volume 33 to an access path P2 between the server devices 41, 42 and 43 and the 64-bit aggregate volume 34.

Suppose, although a new 64-bit aggregate volume is intended to be generated, that no HDD 20 to build a 64-bit aggregate volume may be secured in the aggregate 20b, and that no 64-bit aggregate volume in which all files stored in the 32-bit aggregate volume being a source of the shift may be stored exists. If that is the case, run a process for shifting to a 64-bit aggregate volume by using a following method.

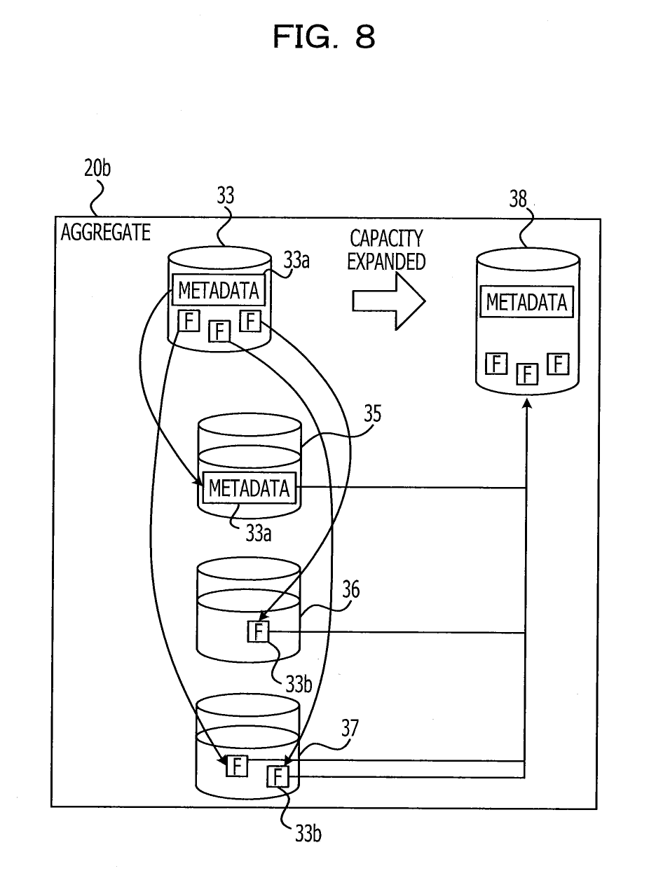

FIG. 8 illustrates a process for shifting to a 64-bit aggregate volume.

The aggregate controller 14 refers to the fields of the aggregate volume size and the used capacity in the volume information management table 141 which manages the respective aggregate volumes, and checks unused storage capacity (in which no file is written) values of the respective aggregate volumes. Then, the aggregate controller 14 checks whether an aggregate volume having an unused storage capacity which is larger than the storage capacity of the 32-bit aggregate volume 33 being the source of the shift exists. If an aggregate volume having an unused storage capacity which is larger than the storage capacity of the 32-bit aggregate volume 33 being the source of the shift exists, set the aggregate volume as a volume into which the file 33b stored in the 32-bit aggregate volume is temporarily copied (called a temporary copy destination volume, hereafter). Incidentally, the temporary copy destination volume may be a 32-bit aggregate volume as well as a 64-bit aggregate volume. Further, the number of the temporary copy destination volumes may be one or two and over. In FIG. 8, e.g., three temporary copy destination volumes 35, 36 and 37 are depicted. The sum of unused storage capacity values of the three temporary copy destination volumes 35, 36 and 37 is greater than the storage capacity value of the 32-bit aggregate volume 33.

The aggregate controller 14 copies the metadata 33a into the temporary copy destination volume 35. After finishing copying the metadata 33a into the temporary copy destination volume 35, the aggregate controller 14 copies the file 33b stored in the 32-bit aggregate volume 33 separately into the temporary copy destination volumes 36 and 37. Then, the aggregate controller 14 releases the 32-bit aggregate volume 33 and generates a 64-bit aggregate volume 38 having a larger storage capacity than the storage capacity of the 32-bit aggregate volume 33. Then, the aggregate controller 14 copies the metadata 33a stored in the temporary copy destination volume 35 and the file 33b stored in the temporary copy destination volumes 36 and 37 into the 64-bit aggregate volume 38 having been generated. When copying the metadata 33a, the aggregate controller 14 updates and arranges data included in the metadata 33a for the 64-bit aggregate volume 38, i.e., the destination of the shift. The aggregate controller 14, e.g., updates and changes the access path included in the metadata 33a between the server devices 41-43 and the 32-bit aggregate volume 33 to an access path between the server devices 41-43 and the 64-bit aggregate volume 38. Then, the aggregate controller 14 deletes the metadata 33a stored in the temporary copy destination volume 35 and the file 33b stored in the temporary copy destination volumes 36 and 37.

Incidentally, make use of the resources such as the CPU 101, the cache memory 104, etc., in order to run a process for shifting a volume. Thus, if there are plural 32-bit aggregate volumes to be sources of the shift, the aggregate controller 14 preferably arranges a phased shift so that these 32-bit aggregate volumes are shifted one by one to the 64-bit aggregate volume.

As described above, the aggregate controller 14 of the storage apparatus 100 runs the process in the operation S11 depicted in FIG. 6, so that the 32-bit aggregate volume in which files relatively frequently updated within latest six months are stored, although the upper limit of the total number of files is close, may be shifted to the 64-bit aggregate volume. Owing to the shift to the 64-bit aggregate volume, an increase in size of existing files may be dealt with. Thus, repeated production of an aggregate volume may be controlled and a load of the shift processing may be reduced. If a 32-bit aggregate volume in which files relatively infrequently updated within latest six months are stored, while the upper limit of the total number of files is close, is shifted to a 64-bit aggregate volume so that the storage capacity increases, the increase in the storage capacity will probably remain unused. Thus, the aggregate controller 14 does not shift such a 32-bit aggregate volume to a 64-bit aggregate volume, as in the operation 12 depicted in FIG. 6. The storage apparatus 100 may thereby save the storage area in the aggregate 20b compared with typical shifting to a 64-bit aggregate volume.

Further, as the OS is updated from the first version to the second version, the process depicted in FIG. 6 is run for every 32-bit aggregate volume and the process for shifting to a 64-bit aggregate volume is automatically run depending upon usage condition. The process for shifting to a 64-bit aggregate volume may thereby be facilitated. Further, the shifting process is run quickly compared with being manually shifted by a user. Thus, an influence of delayed file access from the server device 41, 42 or 43 to the storage apparatus 100 may thereby be reduced.

The control device, control method and storage apparatus of the disclosure has been explained above on the basis of the embodiments depicted in the drawings. The disclosure is not limited to the embodiments. Each of portions of the embodiments may be replaced with something having a similar function and any structure. Further, any other components or steps may be added to the embodiments.

Further, any two and over portions (features) of the embodiments described above may be combined with one another.

Incidentally, the processing functions described above may be implemented by unit of a computer. If that is the case, a program in which what is processed by the functions that the control device 2 and the controller 10 have is written is provided. The computer runs the program so that the above functions are implemented on the computer. The program in which what is processed is written may be recorded on a computer-readable recording medium. The computer-readable recording medium may be a magnetic storage apparatus, an optical disk, a magneto-optical recording medium, a semiconductor memory, etc. The magnetic storage apparatus may be a hard disk drive, a flexible disk (FD), a magnetic tape, etc. The optical disk may be a DVD (Digital Versatile Disc), a DVD-RAM, a CD-ROM (Compact Disc Read Only Memory)/RW (ReWritable), etc. The magneto-optical recording medium may be an MO (Magneto-Optical disk), etc.

In order to distribute a program, e.g., put a removable recording medium such as a DVD, CD-ROM, etc. on which the program is recorded on the market. Further, if the program is filed in a storage apparatus of a server computer, the program may be transferred from the server computer to another computer.

A computer which runs a program files a program recorded on a removable recording medium or transferred from a server computer in a storage apparatus of its own. Then, the computer reads the program from the storage apparatus of its own, and runs a process according to the program. Incidentally, the computer may read the program directly from the removable recording medium so as to run a process according to the program. Further, each time the program is transferred from the server computer that the computer is connected with via a network, the computer may successively run a process according to the received program.

Further, at least part of the above processing functions may be implemented by unit of an electronic circuit such as a DSP (Digital Signal Processor), an ASIC (Application Specific Integrated Circuit), a PLD (Programmable Logic Device), etc.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A control device comprising:
a counter configured to count the number of files stored in a first volume having a data storage area to which an upper limit of the number of files which being stored in the data storage area is set;
an interpreting unit configured to interpret an inclination to increase in a capacity of the files stored in the first volume upon the number of the files counted by the counter being greater than a particular number; and
a volume controller configured to generate a second volume when the interpreting unit interprets the inclination as such that the capacity of the files increases by an amount greater than a particular amount within a certain time length.

2. The control device according to claim 1,
wherein the volume controller avoids generating the second volume by expanding the data storage area in the first volume when the interpreting unit interprets the inclination as such that the capacity of the files does not increase by an amount greater than a particular amount within a certain time length.

3. The control device according to claim 2,
wherein the number of bits that the second volume uses as a basis on which an address indicating a data storage area is managed is greater than the number of bits that the first volume uses as a basis on which an address indicating a data storage area is managed.

4. The control device according to claim 1,
wherein the volume controller works when an operation system of the control device is updated.

5. The control device according to claim 1,
wherein the first volume is formed by part of a data storage area in a storage pool having a plurality of disks, and so is the second volume.

6. The control device according to claim 1, further comprising:
a shift processor configured to copy a file stored in the first volume into the second volume made by the volume controller.

7. A control method comprising:
counting the number of files stored in a first volume having a data storage area to which an upper limit of the number of files which being stored in the data storage area is set;
interpreting, by a processor, an inclination to increase in a capacity of the files stored in the first volume when the counted number of the files is greater than a particular number; and
generating a second volume upon interpreting the inclination as such that the capacity of the files increases by an amount greater than a particular amount within a certain time length.

8. The control method according to claim 7,
wherein a volume controller avoids generating the second volume by expanding a data storage area in the first volume when the processor interprets the inclination as such that the capacity of the files does not increase by an amount greater than a particular amount within a certain time length.

9. The control method according to claim 8,
wherein the number of bits that the second volume uses as a basis on which an address indicating a data storage area is managed is greater than the number of bits that the first volume uses as a basis on which an address indicating a data storage area is managed.

10. The control method according to claim 7,
wherein the second volume is generated when an operation system of a relevant control device is updated.

11. The control method according to claim 7,
wherein the first volume is formed by part of a data storage area in a storage pool having a plurality of disks, and so is the second volume.

12. The control method according to claim 7, further comprising:
copying a file stored in the first volume into the second volume generated by the generating of the second volume so as to run a shift process.
